(19) United States
(12) Patent Application Publication
(10) Pub. No.: US 2023/0410002 A1
(43) Pub. Date: Dec. 21, 2023

(54) METHOD AND DEVICE FOR JOB SCHEDULING FOR GIG WORKER

(71) Applicant: ENTERPRISE BLOCKCHAIN CO., LTD., Seoul (KR)

(72) Inventors: Seonghyuck YOO, Seoul (KR); Jihyun LEE, Yongin-si (KR); Junsup LEE, Seoul (KR); Yongwook KIM, Seoul (KR)

(73) Assignee: ENTERPRISE BLOCKCHAIN CO., LTD., Seoul (KR)

(21) Appl. No.: 18/036,989

(22) PCT Filed: Nov. 9, 2021
(86) PCT No.: PCT/KR2021/016238

§ 371 Date: May 15, 2023

(30) Foreign Application Priority Data
Dec. 9, 2020 (KR) 10-2020-0171038

(51) Int. Cl. G06Q 10/0631

(52) U.S. Cl. CPC G06Q 10/063118

(57) ABSTRACT

Disclosed are a method and device for job scheduling for a gig worker, the device comprising: a data obtaining unit obtaining gig service completion data and gig service request data generated in a preset time section or a preset space section; and a prediction unit predicting a gig service load rate, a gig service rate, the number of gig workers to provide a gig service, and the number of gig service requests to be generated in a particular time section or a particular space section on the basis of at least one piece of the gig service completion data and the gig service request data, wherein the prediction unit, on the basis of at least one piece of the gig service completion data, further predicts the number of gig services that a gig worker is capable of performing in the particular time section or the particular space section; and further predicts the income of each gig worker on the basis of the gig service rate and the number of gig services that the gig worker is capable of performing.

### TECHNICAL FIELD

The present invention relates to a job scheduling method and device for a gig worker, and more particularly, to a job scheduling method and device for a gig worker that maximizes an income of the gig worker predicted based on a learning model for a service execution capability of the gig worker, but generates job scheduling information for the gig worker to optimize distribution of the gig service among gig workers considering a gig service load rate predicted based on a learning model that has learned past gig service request/complete data.

### BACKGROUND ART

With the development of digital technology, the world is connected by a digital network, and the convergence of industries through the Fourth Industrial Revolution is increasing, and an economic method called the “gig economy” is gaining attention. The gig economy is a type of economy in which people are hired as needed in industrial sites and temporarily contracted to do work. The term “gig” refers to temporary labor traded on digital platforms, and has recently evolved to mean a provider (or gig worker) who provides services on a short-term contract basis to online platforms. In the present invention, a worker who engages in temporary, fixed-term labor activities is defined as a gig worker. Gig services are fixed-term labor services that are temporarily contracted and traded on digital platforms as needed, such as cleaning agencies and delivery agencies, and are not limited to specific types. Gig platform refers to a platform that receives gig service orders from gig service users and requests services from gig workers, and gig platform operator refers to an operator that provide a gig platform.

According to the gig economy, companies may use gig workers with the desired ability when necessary, which is advantageous in terms of securing labor flexibility and reducing labor costs. Further, gig workers may work when they want, making it easy to manage time and reduce low barriers to entry into gig-related industrial sites. In particular, the gig service market is also exploding as the transition to the digital age and concerns over disease infection caused by viruses accelerate the transition to a society in which all areas of daily life are made in a non-face-to-face manner.

Currently, the gig platform is suffering from a shortage of gig workers compared to the soaring number of gig service requests (hereinafter referred to as work). There is a perception that gig service labor is easy and anyone may do it, but contrary to this perception, efficient job scheduling based on existing experience may increase the productivity of gig workers. Therefore, there is a need for a job scheduling plan that may maximize the productivity of each gig worker on the gig platform and optimally distribute work to all gig workers.

### DETAILED DESCRIPTION OF THE INVENTION

### Technical Problem

The present invention has been devised to address the above-described technical problems, and it is an object of the present invention to substantially compensate for various problems caused by limitations and disadvantages in the prior art. The present invention provides a job scheduling method and device for a gig worker that maximizes an income of the gig worker predicted based on a learning model for a service execution capability of the gig worker, but generates job scheduling information for the gig worker to optimize distribution of the gig service among gig workers considering a gig service load rate predicted based on a learning model that has learned past gig service request/complete data, and a computer-readable recording medium that records a program for executing the method.

### Technical Solution

According to an embodiment of the present invention, a method for job scheduling for a gig worker comprises obtaining gig service request data and gig service completion data generated in a preset time section or a preset space section, predicting the number of gig service requests to occur in the specific time section or the specific space section, the number of gig workers to provide a gig service, a gig service unit price, and a gig service load rate, based on at least one of the gig service request data and the gig service completion data, predicting the number of gig services that may be performed by a gig worker in the specific time section or the specific space section, based on at least one of the gig service completion data, and predicting an income of each gig worker based on the gig service unit price and the number of gig services that may be performed by the gig worker.

According to an embodiment of the present invention, the method further comprises obtaining a time, region, and number of gig services preferred by the gig worker based on an external input of the gig worker and generating job scheduling information about each gig worker to maximize the predicted income of the gig worker based on the time, the region, and the number of gig services preferred by the gig worker and to optimize distribution of the gig service among gig workers considering the gig service load rate.

According to an embodiment of the present invention, the gig service request data includes at least one of a service type, a service request time, a service request region, a service price, a service management point, information about a service requester, history information about the service requester, and service feedback information.

According to an embodiment of the present invention, the gig service completion data includes at least one of a service type, a service request time, a service request region, a service completion time, a service price, a service distance, a time allocated to a gig allocation, information about an allocated gig, history information about the allocated gig, a service management point, and service feedback information.

According to an embodiment of the present invention, the gig service load rate indicates the number of gig service requests relative to the number of gig workers in the specific time section or the specific space section.

According to an embodiment of the present invention, predicting the number of gig service requests to occur in the specific time section or the specific space section, the number of gig workers to provide the gig service, the gig service unit price, and the gig service load rate includes generating a learning model by deep-learning the at least one gig service request data and the gig service completion data.

According to an embodiment of the present invention, predicting the number of gig service requests to occur in the specific time section or the specific space section, the number of gig workers to provide the gig service, the gig service unit price, and the gig service load rate includes analyzing a degree of association between at least one of the gig service request data and the gig service completion data and external data and assigning a weight to the number of gig service requests to occur in the specific time section or the specific space section, the number of gig workers to provide the gig service, the gig service unit price, and the gig service load rate, based on the degree of association.

According to an embodiment of the present invention, the external data includes at least one of topographic information about the specific space section, resident population information about the specific space section, weather information in the specific time section or the specific space section, and holiday information.

According to an embodiment of the present invention, predicting the number of gig services that may be performed by the gig worker in the specific time section or the specific space section includes generating a learning model for a service execution capability of a gig worker by deep-learning the at least one gig service completion data. Predicting the number of gig services that may be performed by the gig worker in the specific time section or the specific space section includes predicting the number of gig services that may be performed by the gig worker based on the learning model for the service execution capability of the gig worker. The gig service execution capability of the gig worker includes at least one of an average service execution time of the gig worker and an average service execution speed of the gig worker for the gig service generated in the specific time section or the specific space section.

According to an embodiment of the present invention, generating the job scheduling of each gig worker includes learning the job scheduling information while changing the job scheduling information, with maximization of the predicted income of the gig worker and optimization of distribution of the gig service according to the gig service load rate, as a reward, by neural network-based reinforcement learning.

According to an embodiment of the present invention, the method further comprises transmitting, to an external terminal, at least one of job scheduling information about a predetermined gig worker and a predicted income of the gig worker from among generated job scheduling information about each gig worker by an external request.

Further, according to an embodiment of the present invention, there is included a computer-readable recording medium recording a program for performing the method.

Further, according to an embodiment of the present invention, a device for job scheduling for a gig worker comprises a data obtainer obtaining gig service request data and gig service completion data generated in a preset time section or a preset space section and a predictor predicting the number of gig service requests to occur in the specific time section or the specific space section, the number of gig workers to provide a gig service, a gig service unit price, and a gig service load rate, based on at least one of the gig service request data and the gig service completion data. The predictor further predicts the number of gig services that may be performed by a gig worker in the specific time section or the specific space section, based on at least one of the gig service completion data and further predicts an income of each gig worker based on the gig service unit price and the number of gig services that may be performed by the gig worker.

According to an embodiment of the present invention, the device further comprises a gig worker inputter obtaining a time, region, and number of gig services preferred by the gig worker based on an external input of the gig worker and a job scheduling generator generating job scheduling information about each gig worker to maximize the predicted income of the gig worker based on the time, the region, and the number of gig services preferred by the gig worker and to optimize distribution of the gig service among gig workers considering the gig service load rate.

According to an embodiment of the present invention, the gig service request data includes at least one of a service type, a service request time, a service request region, a service price, a service management point, information about a service requester, history information about the service requester, and service feedback information.

According to an embodiment of the present invention, the gig service completion data includes at least one of a service type, a service request time, a service request region, a service completion time, a service price, a service distance, a time allocated to a gig allocation, information about an allocated gig, history information about the allocated gig, a service management point, and service feedback information.

According to an embodiment of the present invention, the gig service load rate indicates the number of gig service requests relative to the number of gig workers in the specific time section or the specific space section.

According to an embodiment of the present invention, the predictor generates a learning model by deep-learning the at least one gig service request data and the gig service completion data.

According to an embodiment of the present invention, the predictor analyzes a degree of association between at least one of the gig service request data and the gig service completion data and external data and assigns a weight to the number of gig service requests to occur in the specific time section or the specific space section, the number of gig workers to provide the gig service, the gig service unit price, and the gig service load rate, based on the degree of association.

According to an embodiment of the present invention, the external data includes at least one of topographic information about the specific space section, resident population information about the specific space section, weather information in the specific time section or the specific space section, and holiday information.

According to an embodiment of the present invention, the predictor generates a learning model for a service execution capability of a gig worker by deep-learning the at least one gig service completion data and predicts the number of gig services that may be performed by the gig worker based on the learning model for the service execution capability of the gig worker. The gig service execution capability of the gig worker includes at least one of an average service execution time of the gig worker and an average service execution speed of the gig worker for the gig service generated in the specific time section or the specific space section.

According to an embodiment of the present invention, the job scheduling generator learns the job scheduling information while changing the job scheduling information, with maximization of the predicted income of the gig worker and optimization of distribution of the gig service according to the gig service load rate, as a reward, by neural network-based reinforcement learning.

According to an embodiment of the present invention, the device further comprises a job scheduling provider transmitting, to an external terminal, at least one of job scheduling information about a predetermined gig worker and a predicted income of the gig worker from among generated job scheduling information about each gig worker by an external request.

### Advantageous Effects

Through the job scheduling device for the gig worker according to the present invention, it is possible to predict the expected income for each gig worker through learning and predicting the service execution capability of the gig worker for a specific time and space, the number of gig service requests, the number of gig workers, and the unit price of each gig service, and provide the predicted expected income information to the gig worker.

Further, according to the present invention, a gig worker may be provided with personalized job scheduling information according to his/her preferred region, time, and the number of gig services, so that even an inexperienced gig worker or a gig worker whose working environment has changed, such as region/time, may earn stable profits. The job scheduling device for the gig worker according to the present invention may derive the personalized job scheduling information to maximize expected income for each gig worker through artificial intelligence learning and to optimize job distribution for each gig worker. Accordingly, according to the present invention, it is possible to reduce the waiting time for providing the gig service by efficiently distributing all the gig workers according to the region/time, thereby preventing the situation in which the gig workers are saturated or insufficient in a specific region/time.

### BRIEF DESCRIPTION OF DRAWINGS

FIG. 1 is a schematic block diagram of a job scheduling system of a gig worker according to an embodiment of the present invention.

FIG. 2 illustrates an embodiment of predicting the number of gig service requests, the number of gig workers to provide a gig service, a gig service unit price, a gig service load rate, and the number of gig services that a gig worker may perform, according to an embodiment of the present invention.

FIG. 3 is a schematic first flowchart of a job scheduling method for a gig worker according to an embodiment of the present invention.

FIG. 4 is a schematic second flowchart of a job scheduling method for a gig worker according to an embodiment of the present invention.

FIG. 5 is a schematic block diagram of a job scheduling device for a gig worker according to an embodiment of the present invention.

### MODE FOR CARRYING OUT THE INVENTION

Hereinafter, preferred embodiments of the present invention are described in detail with reference to the accompanying drawings. In the drawings, the same reference numerals refer to the same elements, and the size of each component in the drawings may be exaggerated for clarity of description.

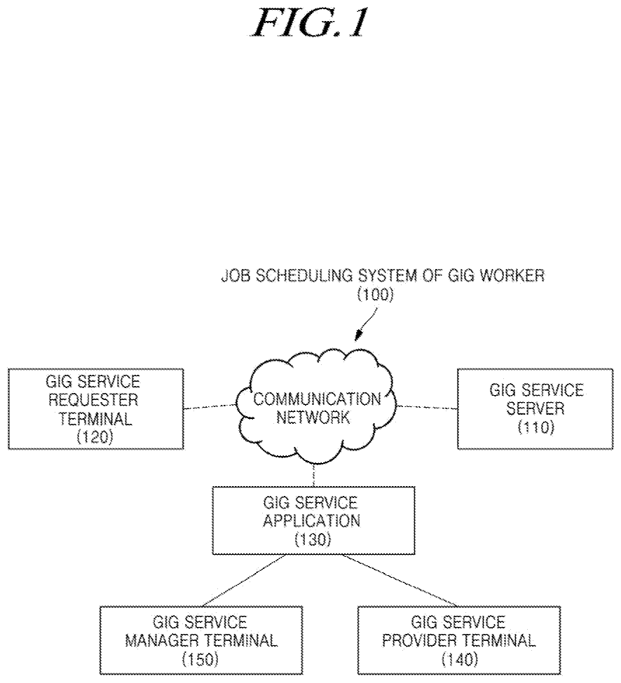

FIG. 1 is a schematic block diagram of a job scheduling system of a gig worker according to an embodiment of the present invention.

A job scheduling system 100 of a gig worker according to an embodiment of the present invention includes a gig service server 110, a gig service requester terminal 120, a gig service application 130, a gig service provider terminal 140, and a gig service manager terminal 150.

The gig service server 110 obtains gig service request data generated in a predetermined time section or a predetermined space section from the gig service requester terminal 120 to predict the number of gig service requests to occur in a specific time section or a specific space section in the future, the number of gig workers to provide the gig service, the gig service unit price, and the gig service load rate, and obtains gig service completion data from the gig service application 130. The gig service load rate indicates the number of gig service requests relative to the number of gig workers in the specific time section or the specific space section. Further, the gig service server 110 obtains gig service completion data from the gig service application 130 to predict the number of gig services that may be performed by the gig worker in the specific time section or the specific space section. The gig service application 130 receives the gig service completion data from the gig service provider terminal 140 or the gig service manager terminal 150. Also, the gig service server 110 may obtain the gig service completion data from the gig service requester terminal 120.

There may be provided a plurality of gig service requester terminals 120, a plurality of gig service provider terminals 140, and a plurality of gig service manager terminals 150, and as the number of the terminals and the accumulated gig service request data and gig service completion data increase, prediction accuracy for the number of gig service requests, etc. may be increased.

The gig service request data includes at least one of a service type, a time when the gig service is requested, a region where the gig service is requested, a price at which the gig service is requested, information about the service management point for allocating the gig to the requested gig service, service requester information, history information about the service requester, or service feedback information. The service type includes the types of services such as delivery agencies and cleaning agencies, and it is obvious to those skilled in the art that it is not limited to specific service types. The history information about the service requester includes a service request pattern such as a time and region preferred for service by the requester, a preferred service type, and the like. The service feedback information includes information about whether the requested gig service is completed, a degree of satisfaction, and whether the same gig service is intended to be re-requested.

The gig service completion data may include at least one of a completed gig service type, a time when the gig service is requested, a region where the gig service is requested, a time when the gig service is completed, a gig service provision price, a gig service provision distance, a time for gig allocation after the gig service is requested, information about the allocated gig, history information about the allocated gig, a service management point for allocating the gig to the requested gig service, or service feedback information. The information about the allocated gig or the history information about the allocated gig may include a gig service provision pattern such as a time and a region where the gig service is provided, a preferred service type, or the like, and the service feedback information may include a degree of satisfaction of the requester to the gig service.

The gig service server 110 predicts the number of gig service requests to occur in a specific time section or a specific space section, the number of gig workers to provide the gig service, a gig service unit price, and a gig service load rate, based on at least one of the gig service request data and the gig service completion data. The gig service server 110 may generate a learning model by deep-learning the at least one gig service request data and the gig service completion data, and predict the number of gig service requests to occur in a specific time section or a specific space section, the number of gig workers to provide the gig service, a gig service unit price, and a gig service load rate based on the learning model. The time section may be set to hour(s), day(s), month(s), or year(s), and the space section may be set as a section divided by a road name address or a city such as Seoul and Busan. For example, the gig service server 110 may predict, based on at least one of the gig service request data and the gig service completion data, data that 120 delivery service requests occur between 11:00 and 12:00 in Uijeongbu 1-dong, Uijeongbu-si, 20 gig workers are present, a delivery unit price is 3,500 Won per case, and a gig service load rate is 6 cases.

Further, the gig service server 110 may increase the accuracy of the predicted data by combining the external data. The external data includes at least one of topographic information about the space section, resident population information about the space section, weather information about the time section or the space section, or holiday information.

For example, the gig service server 110 may predict the type of service and the number of services to be requested in the vicinity of a university district in the upcoming weekend morning based on the type of service and the number of services requested in the vicinity of the university district every weekend morning for one year. In this case, if the university is a women's university, the requested gig service type may vary due to the high proportion of women among the resident population. Further, since people often refrain from going out and order delivery food on rainy days, the number of gig service requests for delivery agencies may increase as compared to other non-rainy days.

As described above, the type or number of gig services requested may vary due to external factors such as resident population information, weather, etc. Given this, the gig service server 110 generates highly accurate prediction data by reflecting the external data.

Also, the gig service server 110 predicts the number of gig services that may be performed by a gig worker in a specific time section or a specific space section, based on at least one of the gig service completion data. The gig service server 110 generates the learning model for the service execution capability of the gig worker by deep-learning the at least one gig service completion data, and predicts the number of gig services that the gig worker may perform based on the learning model. The gig worker's gig service execution capability includes at least one of an average service execution time of the gig worker and an average service execution speed of the gig worker for the gig service generated in the specific time section or the specific space section. For example, delivery driver A has gig service execution capability information with an average delivery time of 32 minutes and an average delivery speed of 32 km/h between 11 and 12 in Uijeongbu 1-dong, Uijeongbu-si. Based on the gig worker's gig service execution capability, delivery driver A may predict that six delivery services may be performed between 11:00 and 12:00 in Uijeongbu 1-dong, Uijeongbu-si.

The gig service server 110 predicts the income of each gig worker based on the predicted gig service unit price and the predicted number of gig services that the gig worker may perform. For example, delivery man A may be expected to earn 26,000 won (the predicted gig service unit price*the number of gig services that gig workers may perform) between 11:00 and 12:00 in Uijeongbu 1-dong, Uijeongbu-si.

The gig service server 110 obtains the time, the region, and the number of gig services preferred by the gig worker based on an external input of the gig worker. The gig service server 110 generates job scheduling information about each gig worker, to maximize the predicted income of the gig worker based on the time, region, and number of gig services preferred by the gig worker and to optimize the distribution of the gig service among the gig workers considering the gig service load rate. The gig service server 110 generates job scheduling information about each gig worker based on the time, the region, and the number of gig services preferred by the gig worker by repeating the learning process while changing job scheduling information with the maximization of predicted income of the gig worker and optimization of distribution of the gig service according to the gig service load rate as a reward. According to an embodiment of the present invention, the gig service server 110 may repeat learning while changing job scheduling information using neural network-based reinforcement learning with the maximization of predicted income of the gig worker and the optimization of the distribution of the gig service according to the gig service load rate as a reward, but it is obvious to those skilled in the art that another learning algorithm may be used.

According to the present embodiment of the present invention, through the gig service server 110 that provides job scheduling of the gig worker, income for each gig worker may be predicted through learning and predicting the service execution capability of the gig worker for time and space, the number of gig service requests, the number of gig workers, and the unit price of the gig service, and predicted income information may be provided to the gig worker.

Further, according to the present embodiment, a gig worker may be provided with personalized job scheduling information according to his/her preferred region, time, and the number of gig services, so that even an inexperienced gig worker or a gig worker whose working environment has changed, such as region/time, may earn stable profits. The gig service server 110 according to the present embodiment may derive the personalized job scheduling information to maximize expected income for each gig worker through artificial intelligence learning and to optimize job distribution for each gig worker. Accordingly, according to the present embodiment, it is possible to reduce the waiting time for providing the gig service by efficiently distributing all the gig workers according to the region/time, thereby preventing the situation in which the gig workers are saturated or insufficient in a specific region/time.

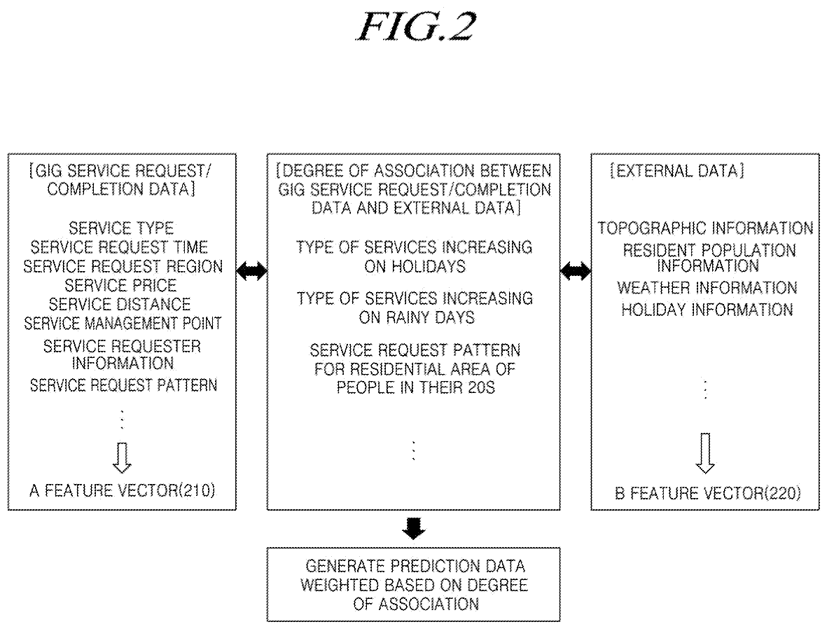

FIG. 2 illustrates an embodiment of predicting the number of gig service requests, the number of gig workers to provide a gig service, a gig service unit price, a gig service load rate, and the number of gig services that a gig worker may perform, according to an embodiment of the present invention.

The gig service server 110 generates vectors 210 and 220 indicating attribute values for the gig service request data and the gig service completion data and attribute values of the external data. The gig service server 110 may learn the degree of association between the gig service request/complete data and the external data based on the vector 210 indicating the feature of the gig service request data and the gig service completion data and the vector 220 indicating the feature of the external data. Further, prediction data produced by assigning a weight to each attribute may be generated based on the learned association degree. Further, the gig service server 110 may generate prediction data by assigning a weight to data obtained in a predetermined recent time section among the gig service request data, the gig service completion data, and the external data.

For example, the gig service server 110 may learn that on a weekend morning, the number of gig service requests for requesting a food delivery agency in a university district is higher than on weekdays, and determine the degree of association between the university district and the weekend. By assigning a weight to the number of service requests to increase the expected number of gig service requests based on the degree of association, it may be predicted that more gig service requests will occur on weekend mornings in university districts.

The learning and prediction method used by the gig service server 110 uses at least one of a machine learning algorithm such as a random forest, or a neural network technology such as a deep neural network (DNN), a convolutional neural network (CNN), a recurrent neural network (RNN), a restricted Boltzmann machine (RBM), a deep belief network (DBN), or a deep Q-networks (DQN), but it is obvious to one of ordinary skill in the art that the learning and prediction method is not limited to a specific algorithm.

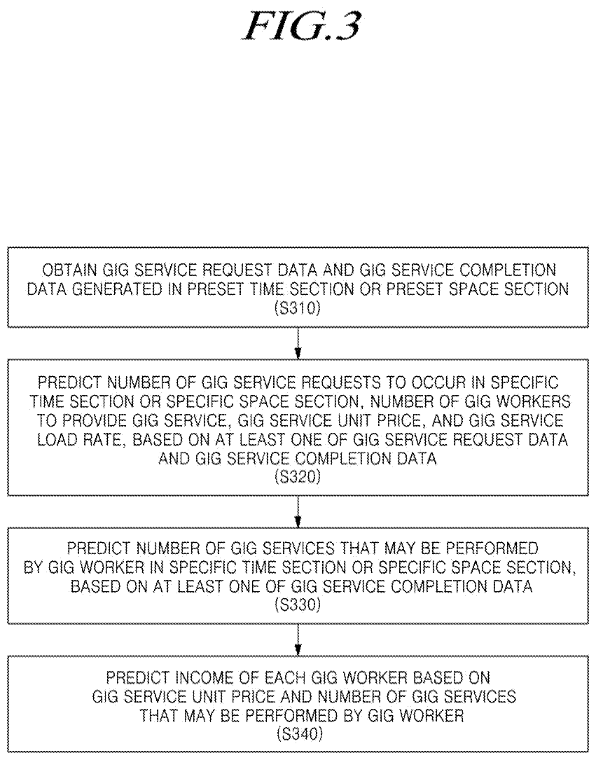

FIG. 3 is a schematic first flowchart of a job scheduling method for a gig worker according to an embodiment of the present invention.

In operation S310, the gig service server 110 obtains gig service request data and gig service completion data generated in a preset time section or a preset space section. The gig service request data includes at least one of a service type, a service request time, a service request region, a service price, a service management point, service requester information, history information about the service requester, and service feedback information. The gig service completion data includes at least one of a service type, a service request time, a service request region, a service completion time, a service price, a service distance, a time allocated to gig allocation, information about the allocated gig, history information about the allocated gig, a service management point, and service feedback information.

In step S320, the gig service server 110 predicts the number of gig service requests to occur in a specific time section or a specific space section, the number of gig workers to provide the gig service, a gig service unit price, and a gig service load rate, based on at least one of the gig service request data and the gig service completion data. The gig service load rate indicates the number of gig service requests relative to the number of gig workers in the specific time section or the specific space section.

The gig service server 110 generates a learning model by deep-learning the at least one gig service request data and the gig service completion data, and predicts the number of gig service requests to occur in a specific time section or a specific space section, the number of gig workers to provide the gig service, a gig service unit price, and a gig service load rate based on the learning model.

The gig service server 110 may analyze the degree of association between at least one of the gig service request data and the gig service completion data and external data. Weights are assigned to the number of gig service requests to occur in the specific time section or the specific space section, the number of gig workers to provide the gig service, the gig service unit price, and the gig service load rate based on the association degree. The external data includes at least one of topographic information about the specific space section, resident population information about the specific space section, weather information about the specific time section or the specific space section, or holiday information.

In step S330, the gig service server 110 predicts the number of gig services that may be performed by a gig worker in the specific time section or the specific space section, based on at least one of the gig service completion data. The gig service server 110 generates the learning model for the service execution capability of the gig worker by deep-learning the at least one gig service completion data, and predicts the number of gig services that the gig worker may perform in the specific time section or the specific space section based on the learning model. The gig worker's gig service execution capability includes at least one of an average service execution time of the gig worker and an average service execution speed of the gig worker for the gig service generated in the specific time section or the specific space section.

In step S340, the gig service server 110 predicts the income of each gig worker based on the gig service unit price and the number of gig services that the gig worker may perform.

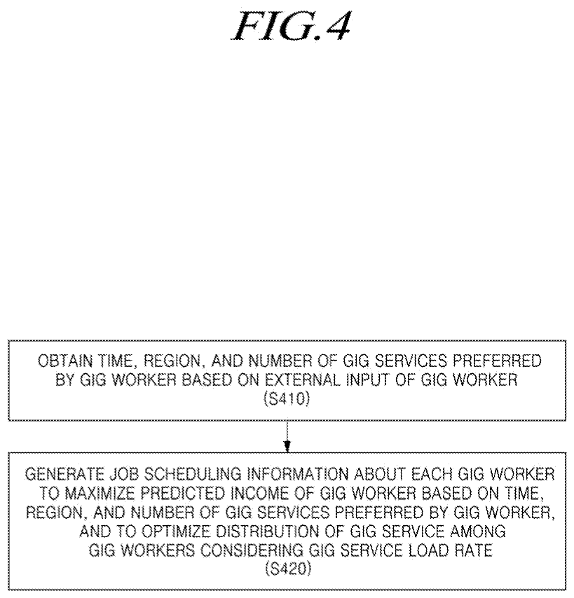

FIG. 4 is a schematic second flowchart of a job scheduling method for a gig worker according to an embodiment of the present invention.

In step S410, the gig service server 110 obtains the time, the region, and the number of gig services preferred by the gig worker based on an external input of the gig worker.

In step S420, the gig service server 110 generates job scheduling information about each gig worker, to maximize the predicted income of the gig worker based on the time, region, and number of gig services preferred by the gig worker and to optimize the distribution of the gig service among the gig workers considering the gig service load rate. The gig service server 110 transmits (not shown), to an external terminal, at least one of the job scheduling information about a predetermined gig worker and the predicted income of the gig worker among the generated job scheduling information about each gig worker by an external request.

The gig service server 110 learns the job scheduling information while changing the job scheduling information with the maximization of the predicted income of the gig worker and the optimization of the distribution of the gig service according to the gig service load rate as a reward. According to an embodiment of the present invention, the gig service server 110 may repeat learning while changing job scheduling information using neural network-based reinforcement learning with the maximization of predicted income of the gig worker and the optimization of the distribution of the gig service according to the gig service load rate as a reward, but it is obvious to those skilled in the art that another learning algorithm may be used.

Specifically, according to the present embodiment, neural network-based multi-agent reinforcement learning in which multiple agents train one neural network is used, and schedulers of individual gig workers are set as agents. The agent, which is the actual active object observes the current status, i.e., the data (e.g., preferred time/region/number of gig services) entered by the gig worker, gig worker analysis and prediction results (e.g., gig worker's predicted income by time and space), and overall gig service prediction data (e.g., gig service load rate by time, number of gig service requests, number of gig workers, gig service unit price) in a specific region. The agent learns job scheduling information that maximizes the predicted income of gig workers and optimizes the distribution of gig services according to the gig service load rate. Job scheduling information in which the predicted income of gig workers is maximized and the distribution of gig services according to the gig service load rate is optimized is derived according to the learned result. For example, job scheduling information (e.g., scheduling information for the next 24 hours) corresponding to a predetermined time section, including ‘delivery driver A performs seven gig services between 11:00 and 12:00 and eight gig services between 12:00 and 1:00 in Uijeongbu 1-dong, Uijeongbu-si’ for example, may be derived. The derived job scheduling information is transmitted to an external terminal and transferred to the gig worker. The agent repeats the process of learning the job scheduling information while changing the job scheduling information with the current status obtained in real-time and the maximization of the predicted income of the gig worker and the optimization of the distribution of the gig service according to the gig service load rate as a reward.

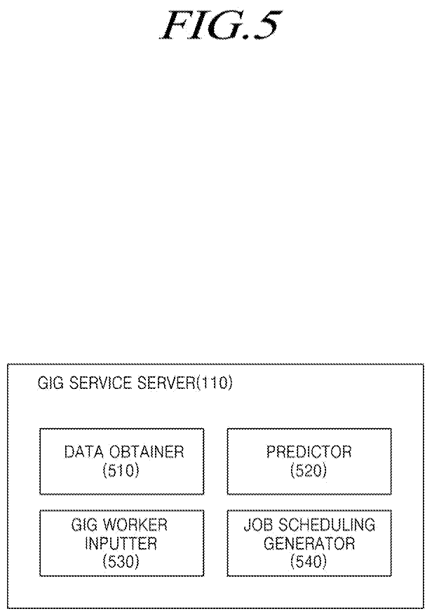

FIG. 5 is a schematic block diagram of a job scheduling device for a gig worker according to an embodiment of the present invention.

A job scheduling device for a gig worker, that is, the gig service server 110, according to the present embodiment includes a data obtainer (or a data obtaining unit) 510, a predictor (or a prediction unit) 520, a gig worker inputter (or a gig worker input unit) 530, and a job scheduling generator (or a job scheduling generating unit) 540. The gig service server 110 may further include a job scheduling provider (or a job scheduling providing unit) (not shown).

The data obtainer 510 obtains gig service request data and gig service completion data generated in a preset time section or a preset space section. The gig service request data includes at least one of a service type, a service request time, a service request region, a service price, a service management point, service requester information, history information about the service requester, and service feedback information. The gig service completion data includes at least one of a service type, a service request time, a service request region, a service completion time, a service price, a service distance, a time allocated to gig allocation, information about the allocated gig, history information about the allocated gig, a service management point, and service feedback information.

The predictor 520 predicts the number of gig service requests to occur in a specific time section or a specific space section, the number of gig workers to provide the gig service, a gig service unit price, and a gig service load rate, based on at least one of the gig service request data and the gig service completion data. The gig service load rate indicates the number of gig service requests relative to the number of gig workers in the specific time section or the specific space section. The predictor 520 generates a learning model by deep-learning the at least one gig service request data and the gig service completion data, and predicts the number of gig service requests to occur in a specific time section or a specific space section, the number of gig workers to provide the gig service, a gig service unit price, and a gig service load rate based on the learning model.

Further, the predictor 520 analyzes the degree of association between at least one of the gig service request data and the gig service completion data and external data. The predictor 520 assigns weights to the number of gig service requests to occur in the specific time section or the specific space section, the number of gig workers to provide the gig service, the gig service unit price, and the gig service load rate based on the association degree. The external data includes at least one of topographic information about the specific space section, resident population information about the specific space section, weather information about the specific time section or the specific space section, or holiday information.

Also, the predictor 520 predicts the number of gig services that may be performed by a gig worker in a specific time section or a specific space section, based on at least one of the gig service completion data. The predictor 520 generates the learning model for the service execution capability of the gig worker by deep-learning the at least one gig service completion data, and predicts the number of gig services that the gig worker may perform in the specific time section or the specific space section based on the learning model. The gig worker's gig service execution capability includes at least one of an average service execution time of the gig worker and an average service execution speed of the gig worker for the gig service generated in the specific time section or the specific space section.

The predictor 520 further predicts the income of each gig worker based on the gig service unit price and the number of gig services that the gig worker may perform.

The gig worker inputter 530 obtains the time, the region, and the number of gig services preferred by the gig worker based on an external input of the gig worker.

The job scheduling generator 540 generates job scheduling information about each gig worker, to maximize the predicted income of the gig worker based on the time, region, and number of gig services preferred by the gig worker and to optimize the distribution of the gig service among the gig workers considering the gig service load rate. The job scheduling generator 540 learns the job scheduling information while changing the job scheduling information with the maximization of the predicted income of the gig worker and the optimization of the distribution of the gig service according to the gig service load rate as a reward, by neural network-based reinforcement learning.

The job scheduling provider (not shown) transmits, to an external terminal, at least one of the job scheduling information about a predetermined gig worker and the predicted income of the gig worker among the generated job scheduling information about each gig worker by an external request.

Although preferred embodiments of the present invention have been described above in detail, the scope of the present invention is not limited thereto, and various modifications and equivalent other embodiments are possible. Thus, the true technical scope of the present invention should be defined by the appended claims.

For example, a device according to an example embodiment of the present invention may include a bus coupled to each of the units of the device as shown, and at least one processor coupled to the bus and may include a memory coupled to the bus to store commands, received messages, or generated messages and coupled to the at least one processor to perform the above-described commands.

Further, the system according to the present invention may be implemented as computer-readable code in a recording medium. The computer-readable recording medium includes all types of recording devices storing data readable by a computer system. The computer-readable recording medium includes a magnetic storage medium (e.g., a ROM, a floppy disk, or a hard disk) or an optical reading medium (e.g., a CD-ROM or a DVD). Further, the computer-readable recording medium may be distributed to computer systems connected via a network, and computer-readable codes may be stored and executed in a distributed manner.

1. A method for job scheduling for a gig worker, the method comprising:
obtaining gig service request data and gig service completion data generated in a preset time section or a preset space section;
predicting the number of gig service requests to occur in the specific time section or the specific space section, the number of gig workers to provide a gig service, a gig service unit price, and a gig service load rate, based on at least one of the gig service request data and the gig service completion data;
predicting the number of gig services that can be performed by a gig worker in the specific time section or the specific space section, based on at least one of the gig service completion data; and
predicting an income of each gig worker based on the gig service unit price and the number of gig services that can be performed by the gig worker.

2. The method of claim 1, further comprising:
obtaining a time, region, and number of gig services preferred by the gig worker based on an external input of the gig worker; and
generating job scheduling information about each gig worker to maximize the predicted income of the gig worker based on the time, the region, and the number of gig services preferred by the gig worker and to optimize distribution of the gig service among gig workers considering the gig service load rate.

3. The method of claim 1, wherein the gig service request data includes at least one of a service type, a service request time, a service request region, a service price, a service management point, information about a service requester, history information about the service requester, and service feedback information.

4. The method of claim 1, wherein the gig service completion data includes at least one of a service type, a service request time, a service request region, a service completion time, a service price, a service distance, a time allocated to a gig allocation, information about an allocated gig, history information about the allocated gig, a service management point, and service feedback information.

5. The method of claim 1, wherein the gig service load rate indicates the number of gig service requests relative to the number of gig workers in the specific time section or the specific space section.

6. The method of claim 1, wherein predicting the number of gig service requests to occur in the specific time section or the specific space section, the number of gig workers to provide the gig service, the gig service unit price, and the gig service load rate includes generating a learning model by deep-learning the at least one gig service request data and the gig service completion data.

7. The method of claim 6, wherein predicting the number of gig service requests to occur in the specific time section or the specific space section, the number of gig workers to provide the gig service, the gig service unit price, and the gig service load rate includes:
analyzing a degree of association between at least one of the gig service request data and the gig service completion data and external data; and
assigning a weight to the number of gig service requests to occur in the specific time section or the specific space section, the number of gig workers to provide the gig service, the gig service unit price, and the gig service load rate, based on the degree of association.

8. The method of claim 7, wherein the external data includes at least one of topographic information about the specific space section, resident population information about the specific space section, weather information in the specific time section or the specific space section, and holiday information.

9. The method of claim 1, wherein predicting the number of gig services that can be performed by the gig worker in the specific time section or the specific space section includes generating a learning model for a service execution capability of a gig worker by deep-learning the at least one gig service completion data,
wherein predicting the number of gig services that can be performed by the gig worker in the specific time section or the specific space section includes predicting the number of gig services that can be performed by the gig worker based on the learning model for the service execution capability of the gig worker, and
wherein the gig service execution capability of the gig worker includes at least one of an average service execution time of the gig worker and an average service execution speed of the gig worker for the gig service generated in the specific time section or the specific space section.

10. The method of claim 2, wherein generating the job scheduling of each gig worker includes learning the job scheduling information while changing the job scheduling information, with maximization of the predicted income of the gig worker and optimization of distribution of the gig service according to the gig service load rate, as a reward, by neural network-based reinforcement learning.

11. The method of claim 2, further comprising transmitting, to an external terminal, at least one of job scheduling information about a predetermined gig worker and a predicted income of the gig worker from among generated job scheduling information about each gig worker by an external request.

12. A device for job scheduling for a gig worker, comprising:
a data obtainer obtaining gig service request data and gig service completion data generated in a preset time section or a preset space section; and
a predictor predicting the number of gig service requests to occur in the specific time section or the specific space section, the number of gig workers to provide a gig service, a gig service unit price, and a gig service load rate, based on at least one of the gig service request data and the gig service completion data,
wherein the predictor is configured to;
further predict the number of gig services that can be performed by a gig worker in the specific time section or the specific space section, based on at least one of the gig service completion data, and
further predict an income of each gig worker based on the gig service unit price and the number of gig services that can be performed by the gig worker.

13. The device of claim 12, further comprising:
a gig worker inputter obtaining a time, region, and number of gig services preferred by the gig worker based on an external input of the gig worker; and
a job scheduling generator generating job scheduling information about each gig worker to maximize the predicted income of the gig worker based on the time, the region, and the number of gig services preferred by the gig worker and to optimize distribution of the gig service among gig workers considering the gig service load rate.

14. The device of claim 12, wherein the predictor is configured to;
generate a learning model for a service execution capability of a gig worker by deep-learning the at least one gig service completion data, and
predict the number of gig services that can be performed by the gig worker in the specific time section or the specific space section, based on the learning model for the service execution capability of the gig worker,
wherein the gig service execution capability of the gig worker includes at least one of an average service execution time of the gig worker and an average service execution speed of the gig worker for the gig service generated in the specific time section or the specific space section.

15. The device of claim 13, wherein the job scheduling generator learns the job scheduling information while changing the job scheduling information, with maximization of the predicted income of the gig worker and optimization of distribution of the gig service according to the gig service load rate, as a reward, by neural network-based reinforcement learning.
